(19) United States
(12) Patent Application Publication
(10) Pub. No.: US 2015/0306539 A1
(43) Pub. Date: Oct. 29, 2015

(54) MICROPOROUS LAMINATED MEMBRANE AND METHOD FOR PRODUCING THE SAME

(71) Applicant: DAICEL CORPORATION, Osaka (JP)

(72) Inventor: Yo YAMATO, Hyogo (JP)

(73) Assignee: DAICEL CORPORATION, Osaka (JP)

(21) Appl. No.: 14/660,470

(22) Filed: Mar. 17, 2015

(30) Foreign Application Priority Data
Apr. 24, 2014 (JP) 2014-090268

(51) Int. Cl. B01D 53/22; B01D 71/56; B01D 71/64; B07B 1/46; B01D 71/26; B01D 61/18; H01M 2/16; H01M 2/14; B01D 67/00; B01D 71/68

(52) U.S. Cl. CPC B01D 53/228; B01D 67/0018; B01D 67/0013; B01D 71/56; B01D 71/64; B01D 71/68; B01D 71/26; B01D 61/18; H01M 2/1686; H01M 2/162; H01M 2/145; B07B 1/4681; B01D 2053/221

(57) ABSTRACT

Disclosed is a microporous laminated membrane including a nonwoven-fabric substrate and a microporous membrane. The microporous membrane is disposed on at least one side of the nonwoven-fabric substrate. The microporous membrane includes a multiplicity of interconnecting micropores. The micropores have an average pore diameter of from 0.01 to 10 μm. The microporous membrane has an arithmetic mean surface roughness Sa of 0.5 μm or less. The microporous laminated membrane has an air permeability of from 0.5 to 30 seconds. The microporous laminated membrane has a tensile strength of 4.0 N/15 mm or more. The microporous laminated membrane does not undergo interfacial peeling between the substrate and the microporous membrane as a result of a tape peel test.

### TECHNICAL FIELD

The present invention relates to microporous laminated membranes and production methods thereof, where the microporous laminated membranes include micropores and have certain handling strength.

More specifically, the present invention relates to a microporous laminated membrane and a production method thereof, where the microporous laminated membrane includes a nonwoven-fabric substrate and a microporous membrane. The microporous membrane is disposed on at least one side of the substrate and includes a multiplicity of interconnecting micropores.

### BACKGROUND ART

Japanese Patent No. 3963765 (PTL 1) discloses a porous film as a microporous membrane containing micropores. The porous film includes an amide-imide polymer or an imide polymer. The porous film has a film thickness of from 5 to 200 μm, an average pore diameter of the micropores of from 0.01 to 10 μm, a porosity of from 30% to 80%, and a Gurley permeability of 0.2 to 29 seconds per 100 cc. The Gurley permeability refers to an air permeability that indicates the interconnectivity of micropores.

PCT International Publication Number WO2007/097249 (PTL 2) discloses a multilayer assembly (laminated membrane) including a nonwoven fabric and, disposed thereon, a porous film (porous membrane). Specifically, PTL 2 discloses a microporous laminated membrane including a nonwoven-fabric substrate and a microporous membrane. The microporous membrane is disposed on at least one side of the substrate and includes a multiplicity of interconnecting micropores. The micropores have an average pore diameter of from 0.01 to 10 μm. In the microporous laminated membrane, the substrate and the microporous membrane undergo approximately no interfacial peeling from each other as a result of a tape peel test.

Japanese Unexamined Patent Application Publication (JP-A) No. 2010-221218 (PTL 3) discloses a sewage/wastewater separation membrane. The separation membrane is a multilayer assembly including a nonwoven fabric and a microporous membrane, where the nonwoven fabric serves as a substrate, and the microporous membrane is disposed on the nonwoven fabric. The nonwoven fabric is formed by fibers such as cellulose fibers, cellulose triacetate fibers, polyester fibers, polypropylene fibers, and polyethylene fibers. In a most preferred embodiment, the multilayer assembly includes a polyester-fiber nonwoven fabric and, disposed thereon, a microporous membrane made from a poly(vinylidene fluoride) (PVDF).

JP-A No. 2006-257888 (PTL 4) discloses an air cleaner filter including a porous sheet and a polyester nonwoven fabric disposed on the porous sheet. The porous sheet is a sintered product of an ultrahigh-molecular-weight polyethylene. The filter is produced by a method including the step 1 of charging an ultrahigh molecular weight polyethylene powder into a mold, placing the resulting mold in a container, and reducing the inside pressure of the container. The container is fed with heated steam, heated at 160° C. and 6 atmospheres for 5 hours, and slowly cooled to give a cylindrical sintered porous body (step 2). The prepared cylindrical sintered porous body is cut into a sheet, and the sheet is drawn or stretched to give a porous sheet (step 3). The porous sheet is coated with a hot-melt pressure-sensitive adhesive, and the hot-melt pressure-sensitive adhesive is placed under and laminated with a polyester nonwoven fabric (step 4).

### CITATION LIST

### Patent Literature

PTL 1: Japanese Patent No. 3963765

PTL 2: PCT International Publication Number WO2007/097249

PTL 3: JP-A No. 2010-221218

PTL 4: JP-A No. 2006-257888

### SUMMARY OF INVENTION

### Technical Problem

Unfortunately, however, the microporous membrane disclosed in PTL 1, as including highly interconnecting micropores, has very low strength, should be handled with care, and is restricted in use. Specifically, such membrane (film) is frequently handled by a roll-to-roll process, but the microporous membrane may disadvantageously fail to surely have such strength as to be impervious to the roll-to-roll process.

The multilayer assembly disclosed in PTL 2 includes the nonwoven fabric as a substrate and, disposed thereon, the microporous membrane. The nonwoven fabric allows the multilayer assembly to surely have sufficient strength. However, the nonwoven fabric structurally includes openings or pores. Assume that the microporous membrane is formed by a method of casting a polymer solution as a film onto the nonwoven fabric as in PTL 2. Disadvantageously in this case, the polymer solution penetrates inside of the openings of the nonwoven fabric, and this causes the microporous membrane to have an uneven surface, to suffer from partial exposure of the nonwoven fabric from the surface, to suffer from pinholes, and/or to have inferior gas permeability. In general, openings of a nonwoven fabric are overwhelmingly larger as compared with micropores of a microporous membrane and are very nonuniform when being microscopically seen. Unfortunately, this causes the polymer solution to penetrate the nonwoven fabric in amounts varying from portion to portion and thereby causes the microporous membrane to have a varying thickness and to have a varying air permeability, where the air permeability features the microporous membrane.

The multilayer assembly disclosed in PTL 3 also includes the nonwoven-fabric substrate and, disposed thereon, the microporous membrane resin layer. The multilayer assembly suffers from disadvantages as above, because the microporous membrane resin layer makes its way into the nonwoven-fabric substrate partially. In addition and disadvantageously, the multilayer assembly has a very low surface opening area rate of the microporous membrane and suffers from variation of air permeability from portion to portion, because the microporous membrane resin layer has a nonuniform pore structure including macrovoids inside of the resin layer.

Unfortunately, it is difficult for the multilayer assembly (filter) disclosed in PTL 4 to have a smaller pore diameter and a lower surface opening area rate, because the multilayer assembly employs the production method. In addition and disadvantageously, the production method for the filter requires much time and effort as described above. Further unfortunately, the multilayer assembly has inferior gas permeability, because the porous sheet and the polyester nonwoven fabric are bonded through the hot-melt pressure-sensitive adhesive.

Under these circumstances, demands have been made to provides a microporous laminated membrane and a production method thereof, where the microporous laminated membrane has excellent gas permeability, suffers from approximately no pinhole, has a highly smooth surface, is flexible, and can be handled and processed satisfactorily.

Accordingly, it is an object of the present invention to provide a microporous laminated membrane that has excellent gas permeability, suffers from approximately no pinhole, has a highly smooth surface, is flexible, and can be handled and processed satisfactorily. It is another object of the present invention to provide a method for producing the microporous laminated membrane.

### Solution to Problem

After intensive investigations to achieve the objects, the present inventors have found a microporous laminated membrane that is prepared by thermally fusing a nonwoven-fabric substrate with a microporous membrane to laminate the microporous membrane on the nonwoven-fabric substrate; and have found that the microporous laminated membrane has excellent gas permeability, suffers from approximately no pinhole, has a highly smooth surface, is flexible, and can be handled and processed satisfactorily. In addition, the present inventors have found that a regular microporous laminated membrane prepared by coating a nonwoven-fabric substrate with a microporous membrane material suffers from various disadvantages and becomes unable to withstand use. Typically, the microporous membrane has an uneven surface, the nonwoven fabric is exposed from the surface partially, pinholes are formed, and/or the microporous laminated membrane has inferior gas permeability. The present invention has been made based on these findings.

Specifically, the present invention provides, in one aspect, a microporous laminated membrane including a nonwoven-fabric substrate and a microporous membrane. The microporous membrane is disposed on at least one side of the nonwoven-fabric substrate. The microporous membrane includes a multiplicity of interconnecting micropores. The micropores have an average pore diameter of from 0.01 to 10 μm. The microporous membrane has an arithmetic mean surface roughness Sa of 0.5 μm or less as determined by a measurement method mentioned below. The microporous laminated membrane has an air permeability of from 0.5 to 30 seconds. The microporous laminated membrane has a tensile strength of 4.0 N/15 mm or more. The microporous laminated membrane does not undergo interfacial peeling between the substrate and the microporous membrane as a result of a tape peel test. The tape peel test is performed in a manner as follows.

Tape Peel Test

A masking tape [trade name Film Masking Tape No. 603 (#25) supplied by Teraoka Seisakusho Co., Ltd., having a width of 24 mm] is applied onto a microporous membrane surface of the microporous laminated membrane, compression-bonded to the microporous membrane using a roller having a diameter of 30 mm under a load of 200 gf to give a bonded assembly, and the bonded assembly is subjected to T-peel using a tensile tester at a peel rate of 50 mm/min.

The arithmetic mean surface roughness Sa is measured by a method as follows.

Measurement of Arithmetic Mean Surface Roughness Sa

A surface profile of the microporous membrane is measured by optical interferometry using Non-contact Surface Measurement System VertScan 2.0 (Ryoka Systems Inc.) to calculate the surface roughness. The measurement is performed in an area of 250 μm by 188 μm. The measurement is performed at an objective lens magnification of 50-fold, at a lens barrel size of 0.5 time the body length, using a no-relay zoom lens and a 530 White wavelength filter in a wave measurement mode in a field of view with a size of 640 μm by 480 μm.

The microporous laminated membrane preferably has an arithmetic mean surface roughness Sa of 0.4 μm or less.

The microporous laminated membrane more preferably has an arithmetic mean surface roughness Sa of 0.3 μm or less.

The microporous laminated membrane furthermore preferably has an arithmetic mean surface roughness Sa of 0.2 μm or less.

The microporous laminated membrane preferably has an air permeability of from 0.5 to 20 seconds.

The microporous laminated membrane more preferably has an air permeability of from 0.5 to 10 seconds.

The microporous laminated membrane furthermore preferably has an air permeability of from 0.5 to 5 seconds.

The microporous membrane may be prepared by a method including casting a polymer solution onto a backing to form a membrane on the backing. The membrane on the backing is brought into a coagulation liquid, the membrane alone is separated from the backing, and the separated membrane is dried to give the microporous membrane.

The polymer solution is preferably a solution mixture that includes 8 to 25 percent by weight of a polymer component, 5 to 50 percent by weight of a water-soluble polymer, 0 to 10 percent by weight of water, and 30 to 82 percent by weight of a water-miscible polar solvent.

The microporous membrane preferably includes at least one resin selected from the group consisting of polyimide resins, polyamide-imide resins, polyetherimide resins, and polyethersulfone resins.

The nonwoven-fabric substrate preferably includes at least one nonwoven fabric selected from the group consisting of polyolefin nonwoven fabrics, polyamide nonwoven fabrics, and multilayer nonwoven fabrics, where the multilayer nonwoven fabrics each include at least one nonwoven fabric selected from the group consisting of polyolefin nonwoven fabrics and polyamide nonwoven fabrics.

The microporous membrane preferably has an average internal porosity (pore content) of from 30% to 80%.

The substrate preferably has a thickness of from 10 to 500 μm.

The microporous laminated membrane preferably has a rate of dimensional change of 5% or less as a result of a high-temperature exposure test. The high-temperature exposure test is performed in a manner as follows.

High-temperature Exposure Test

The laminated membrane integrally including the substrate and the microporous membrane is trimmed to give an approximately rectangular specimen having a width of about 5 cm and a length of about 10 cm. The lengths a1 and b1 of two perpendicular sides of the approximately rectangular specimen are measured. The laminated membrane is placed left stand in a thermostat controlled at 140° C. for 30 minutes, retrieved from the thermostat, and left stand to cool down to room temperature. Thereafter the lengths a2 and b2 of the two perpendicular sides of the approximately rectangular specimen are measured. Rates of dimensional change between a1 and a2 and between b1 and b2 are determined according to formulae below, the rates of dimensional change are averaged, and the average is defined as the rate of dimensional change in the high-temperature exposure test. The formulae are expressed as follows:

Rate(%) of dimensional change between a1 and a2={|a2−a1|/a1}×100; and

Rate(%) of dimensional change between b1 and b2={|b2−b1|/b1}×100.

The microporous laminated membrane is preferably used as at least part of one selected from filters for gas, liquid, or solid; separation membranes for gas, liquid, or solid; and separators for cell or capacitor use.

The present invention provides, in another aspect, a method for producing the microporous laminated membrane. In the method, a microporous membrane including a first resin is prepared. Separately, a nonwoven-fabric substrate including a second resin is prepared. The nonwoven-fabric substrate is thermally fused and bonded with the microporous membrane to laminate with each other. The first resin has a glass transition temperature higher than the melting point of the second resin.

The microporous membrane is preferably prepared by a process including casting a polymer solution onto a backing to form a membrane on the backing. The membrane on the backing is brought into a coagulation liquid. The membrane alone is separated from the backing. The separated membrane is dried to give the microporous membrane.

### Advantageous Effects of Invention

The microporous laminated membrane according to an embodiment of the present invention includes a microporous membrane containing a multiplicity of micropores, is thereby highly flexible, has excellent gas permeability, suffers from approximately no pinhole, and has a highly smooth surface. In addition, the microporous membrane is backed by the substrate, and this allows the microporous laminated membrane to exhibit sufficient strength even when having a high porosity, can endure folding, and can be handled extremely satisfactorily. The method according to another embodiment of the present invention can produce a microporous laminated membrane stably in a simple and easy manner, where the microporous laminated membrane has the properties and has a homogeneous membrane quality. The microporous laminated membrane obtained by the method, as having the properties, is usable typically as at least part of filters and separation membranes for gas, liquid, or solid, and separators for cell or capacitor use. Typically, the microporous laminated membrane is usable as at least part of a liquid separation membrane, a solid separation membrane, or a gas separation membrane.

Specifically, the microporous laminated membrane may be applied to uses such as bag filters, dust collector filters, filters for air conditioning equipment, and automotive filters such as air cleaners, oil cleaners, indoor air cleaning filters, and engine intake air filters. In addition, the microporous laminated membrane is also usable as materials for a wide variety of base materials as or for circuit boards, battery separators, electromagnetic wave control materials (e.g., electromagnetic shielding materials and electromagnetic wave absorbers), electrolytic capacitors, low-dielectric constant materials, cushioning materials, ink image receiving sheets, test papers, insulating materials, heat insulators, cell culture substrata, radiation shielding mat materials, and oil absorbent materials.

### BRIEF DESCRIPTION OF DRAWINGS

FIG. 1 is an electron photomicrograph (SEM photomicrograph) of the surface of a microporous membrane prepared in Production Example 1; and

FIG. 2 is an electron photomicrograph (SEM photomicrograph) of the surface of a microporous membrane prepared in Production Example 2.

### DESCRIPTION OF EMBODIMENTS

The microporous laminated membrane according to the embodiment of the present invention will be illustrated in detail below.

Tape Peel Test

The microporous laminated membrane according to the embodiment of the present invention does not undergo interfacial peeling between the substrate and the microporous membrane as a result of the tape peel test.

The tape peel test is performed in a manner as follows. A masking tape [trade name Film Masking Tape No. 603 (#25) supplied by Teraoka Seisakusho Co., Ltd., having a width of 24 mm] is applied onto a microporous membrane surface of the microporous laminated membrane, compression-bonded to the microporous membrane using a roller having a diameter of 30 mm under a load of 200 gf to give a bonded assembly, and the bonded assembly is subjected to T-peel using a tensile tester at a peel rate of 50 mm/min. Specifically, the phrase “does not undergo interfacial peeling between the substrate and the microporous membrane as a result of the tape peel test” refers to that the substrate and the microporous membrane are laminated with each other with such an interlayer adhesive strength as not to cause interfacial peeling as a result of the tape peel test.

The microporous laminated membrane according to the embodiment of the present invention structurally includes the substrate and the microporous membrane directly laminated with each other with a specific interlayer adhesive strength, as has been described above. The microporous laminated membrane is therefore flexible, has excellent pore properties, still has moderate rigidity, and can be handled more satisfactorily. In addition and advantageously, the microporous laminated membrane can select a polymer component to constitute the microporous membrane within a wide range and is applicable as materials in a wide variety of fields. The interlayer adhesive strength between the substrate and the microporous membrane may be adjusted by appropriately determining types of materials constituting the individual layers and interfacial physical properties.

Nonwoven-Fabric Substrate

The microporous laminated membrane according to the embodiment of the present invention structurally includes a nonwoven-fabric substrate and a microporous membrane on at least one side of the substrate.

The nonwoven-fabric substrate may include a single layer or include two or more layers including identical or different materials. The two or more layers may be a multilayer film obtained by preparing two or more nonwoven fabrics and stacking them typically with an adhesive as needed, or obtained by stacking two or more nonwoven fabrics during the production process. The two or more layers may also be obtained by subjecting one or more nonwoven fabrics to a treatment such as coating, vapor deposition, and/or sputtering.

The nonwoven-fabric substrate may have undergone a surface treatment. The surface treatment is exemplified by roughening treatment, adhesion facilitating treatment, antistatic treatment, sand blasting (sand matting), corona discharge treatment, plasma treatment, chemical etching, water matting, flame treatment, acid treatment, alkaline treatment, oxidation, ultraviolet irradiation, and silane coupling agent treatment.

The nonwoven-fabric substrate may have undergone two or more different surface treatments in combination. Typically, in a surface treatment process, the substrate may be initially subjected to a treatment selected typically from corona discharge treatment, plasma treatment, flame treatment, acid treatment, alkaline treatment, oxidation, and ultraviolet irradiation; and thereafter subjected to silane coupling agent treatment. The surface treatment according to this process may exhibit better effects in some types of the substrate as compared with a process employing the silane coupling agent treatment alone. The silane coupling agent is exemplified by products supplied by Shin-Etsu Chemical Co., Ltd. and those supplied by Japan Energy Corporation.

The nonwoven-fabric substrate may have a thickness of typically from 10 to 500 μm, preferably from 10 to 300 μm, more preferably from 10 to 200 μm, and furthermore preferably from 10 to 100 μm. The nonwoven-fabric substrate, if having an excessively small thickness, may be handled with difficulty. In contrast, the nonwoven-fabric substrate, if having an excessively large thickness, may be unsatisfactorily flexible.

The nonwoven-fabric substrate may have a mass per unit area (METSUKE) of typically from 2 to 250 g/m², preferably from 2 to 150 g/m², more preferably from 2 to 100 g/m², and furthermore preferably from 2 to 50 g/m². The range is preferred for maintaining the strength and for offering good flexibility.

The nonwoven-fabric substrate may have a density of typically from 0.05 to 0.90 g/cm³, preferably from 0.10 to 0.80 g/cm³, and furthermore preferably from 0.15 to 0.70 g/cm³. The range is preferred for ensuring moderate gas permeability.

The nonwoven-fabric substrate may have an air permeability of 30 seconds or less, more preferably 20 seconds or less, and furthermore preferably 10 seconds or less. The air permeability has a limit of measurement of about 0.1 second. The substrate herein also includes one having an air permeability of less than 0.1 second.

For better adhesion between the nonwoven-fabric substrate and the microporous membrane, the nonwoven-fabric substrate is preferably subjected to one or more appropriate surface treatments on a surface on which the microporous membrane is to be disposed. The surface treatments are exemplified by sand blasting (sand matting), corona discharge treatment, acid treatment, alkaline treatment, oxidation, ultraviolet irradiation, plasma treatment, chemical etching, water matting, flame treatment, and silane coupling agent treatment. The silane coupling agent usable herein is exemplified as above. The surface of the nonwoven-fabric substrate may be subjected to two or more surface treatments in combination. Some nonwoven-fabric substrates are preferably subjected to the silane coupling agent treatment in combination with one or more other treatments.

Nonwoven Fabric

As used herein the term “nonwoven fabric” refers to a sheet-like article prepared by arranging fibers and joining the fibers with each other by an adhesive, or by fusing force or entangling force of the fibers themselves. The “nonwoven fabric” conceptually also includes so-called paper. The nonwoven fabric may be produced by a generally known process such as paper making process, meltblowing, spunlaying, needlepunching, and electrospinning.

The nonwoven fabric substrate may include a resin whose type can be selected depending typically on its melting point and chemical resistance. The nonwoven fabric for use herein is also available as a commercial product such as a polyolefin nonwoven fabric supplied by Japan Vilene Co., Ltd. (trade name FT-330N); polyolefin nonwoven fabrics supplied by Hirose Paper Mfg Co., Ltd. (trade names 06HOP-2, 06HOP-4, HOP-10H, HOP-30H, HOP-60HCF, and HOP-80H); and bilayer nonwoven fabrics supplied by Hirose Paper Mfg Co., Ltd. (trade names 05EP-50 and 15EP-50).

The nonwoven fabric preferably includes a resin having a melting point lower than the glass transition temperature of a resin constituting the microporous membrane. As long as meeting the requirement, the nonwoven fabric is not limited. The nonwoven fabric is preferably selected typically from polyolefin nonwoven fabrics, polyester nonwoven fabrics, polyamide nonwoven fabrics, bilayer nonwoven fabrics and multilayer nonwoven fabrics including two or more of these nonwoven fabrics. The nonwoven fabric for use herein is more preferably at least one selected from the group consisting of polyolefin nonwoven fabrics and bilayer nonwoven fabrics.

Most of nonwoven fabrics now generally available are those including polyolefin resins (such as polyethylenes and polypropylenes), and others are bilayer nonwoven fabrics such as polypropylene/polyester resin laminates. These are of a multitude of types, are inexpensively available, and are preferred.

Advantageously, the nonwoven-fabric substrate, as employing the above-mentioned nonwoven fabric, can be laminated with the microporous membrane with excellent interlayer adhesive strength typically by thermal fusion bonding. The resulting microporous laminated membrane is flexible, has excellent pore properties, and still has moderate rigidity. Thus, the microporous laminated membrane can advantageously effectively be handled more satisfactorily.

Microporous Membrane

The microporous membrane includes a principal component such as a polymer component. The polymer component is not limited, as long as being capable of forming the microporous membrane, and can be selected as appropriate depending on a material constituting the microporous membrane. The polymer component is exemplified by plastics such as polyimide resins, polyamide-imide resins, polyethersulfone resins, polyetherimide resins, polycarbonate resins, poly(phenylene sulfide) resins, liquid crystalline polyester resins, aromatic polyamide resins, polyamide resins, polybenzoxazole resins, polybenzimidazole resins, polybenzothiazole resins, polysulfone resins, cellulose resins, and acrylic resins. The microporous membrane may include each of different polymer components alone or in combination. In an embodiment, the microporous membrane may include each of different copolymers of the resins alone or in combination. The copolymers are exemplified by graft polymers, block copolymers, and random copolymers. The microporous membrane may further include any of polymers containing the skeleton (polymer chain) of any of the resins in a principal chain or side chain. Specifically, such polymers are exemplified by polysiloxane-containing polyimides each including polysiloxane and polyimide skeletons in a principal chain.

Among them, preferred as the polymer component are those including, as a principal component, any of polyamide-imide resins and polyimide resins. This is because these resins are thermally stable and have excellent chemical resistance and electrical properties. The polyamide-imide resins may generally be produced by allowing trimellitic anhydride to react with a diisocyanate or allowing trimellitic anhydride chloride to react with a diamine to thereby perform polymerization, and imidizing the resulting product. The polyimide resins may be produced typically by allowing a tetracarboxylic acid component to react with a diamine component to give a polyamic acid, and further imidizing the polyamic acid. A polyimide resin after imidization may have inferior solubility. To avoid this, the microporous membrane, when being to include such a polyimide resin, is often produced by shaping or forming the polyamic acid into a microporous membrane, and imidizing the polyamic acid microporous membrane. The imidization may typically be performed thermally or chemically. Preferred examples of the polymer component further include those including, as a principal component, any of polyetherimide resins and polyethersulfone resins.

The microporous membrane may also be any of polytetrafluoroethylene (PTFE) microporous membranes that are known as resinous and heat-resistant microporous membranes.

The microporous membrane may have a thickness of typically from 1 to 100 μm, preferably from 1 to 50 μm, more preferably from 1 to 20 μm, and furthermore preferably from 1 to 10 μm. The microporous membrane, if having an excessively small thickness, may become difficult to produce stably. In contrast, the microporous membrane, if having an excessively large thickness, may have inferior gas permeability.

The microporous membrane includes a multiplicity of interconnecting micropores. The micropores may have an average pore diameter (i.e., average diameter of micropores present inside of the membrane) of from 0.01 to 10 μm, preferably from 0.05 to 5 μm, and more preferably from 0.1 to 2 μm. The microporous membrane, if having an average pore diameter out of the range, may hardly offer desired effects corresponding with the intended use and may have inferior pore properties. Typically, the microporous membrane, if having an excessively small average pore diameter, may cause the microporous laminated membrane to suffer from reduction in gas permeability, cushioning performance, ink permeability, electric insulating properties, and/or thermal insulating properties. The microporous membrane, if having an excessively large average pore diameter, may cause the microporous laminated membrane to have inferior filter performance, to suffer from ink diffusion, and/or to be difficult to bear a fine wiring or interconnection.

The microporous membrane may have an average internal porosity (pore content) of typically from 30% to 80%, preferably from 40% to 80%, and furthermore preferably from 45% to 80%. The microporous membrane, if having a porosity out of the range, may hardly offer desired pore properties corresponding with the intended use. Typically, the microporous membrane, if having an excessively low porosity, may cause the microporous laminated membrane to suffer from inferior gas permeability, a higher dielectric constant, inferior cushioning performance, no or low ink permeability, and/or inferior thermal insulating properties. This microporous laminated membrane may also fail to offer desired effects even when changed with a functional material. The microporous membrane, if having an excessively high porosity, may cause the microporous laminated membrane to have lower strength and/or inferior folding endurance.

The microporous membrane may have a rate of opening area at its surface (surface opening area rate) of typically about 48% or more (e.g., from about 48% to about 80%), and preferably from about 60% to about 80%. The microporous membrane, if having an excessively low surface opening area rate, may offer insufficient permeation performance and/or may fail to allow a functional material charged in the micropores to exhibit its function sufficiently. The microporous membrane, if having an excessively high surface opening area rate, may readily cause the microporous laminated membrane to have insufficient strength and/or unsatisfactory folding endurance.

The microporous membrane may have a surface roughness (arithmetic mean surface roughness Sa) of 0.5 μm or less, preferably 0.4 μm or less, more preferably 0.3 μm or less, and furthermore preferably 0.2 μm or less. The microporous membrane, if having an excessively high surface roughness, may lose surface smoothness to readily allow bubbles to attach thereto typically upon filtration of a liquid, and the portion attached with bubbles may lose a filtering function. In addition, the microporous membrane may ununiformly catch fine particles trapped or collected on the membrane upon filtration to cause the microporous laminated membrane to have inferior filtration efficiency and/or an unstable filtration rate. The surface roughness (arithmetic mean surface roughness Sa) may be determined by measuring the surface profile of the sample by optical interferometry using a non-contact surface measurement system according to a method described in working examples mentioned later.

The microporous membrane has only to be disposed on at least one side of the nonwoven-fabric substrate and may be disposed on both sides of the substrate.

The microporous membrane may have undergone a treatment to be imparted with chemical resistance. This imparts chemical resistance to the microporous laminated membrane. Advantageously, the resulting microporous laminated membrane can resist or prevent troubles such as delamination, swelling, dissolution, and deterioration upon contact with a solvent, an acid, and or an alkali (base) in a variety of applications and uses of the microporous laminated membrane. The treatment to impart chemical resistance is exemplified by physical treatments typically with any of heat, ultraviolet rays, visible light, electron beams, and radioactive rays (radiation); and chemical treatments by coating the microporous membrane typically with a chemical-resistant polymer (polymer being resistant to chemicals).

In an embodiment, the microporous membrane may be coated with a chemical-resistant polymer. The microporous laminated membrane according to this embodiment includes a chemical-resistant coating typically on the microporous membrane surface and on the surfaces of micropores present inside of the membrane and can constitute a chemical-resistant laminated membrane. As used herein the term “chemical(s)” refers to chemical substances known to cause dissolution, swelling, shrinkage, and/or decomposition of resins constituting conventional porous films to impair functions as the porous films. It cannot define unconditionally the kinds of “chemicals”, because they may vary depending on the types of resins constituting the microporous membrane and the substrate. Specifically, however, the chemicals are exemplified by highly polar solvents such as dimethyl sulfoxide (DMSO), N,N-dimethylformamide (DMF), N,N-dimethylacetamide (DMAc), N-methyl-2-pyrrolidone (NMP), 2-pyrrolidone, cyclohexanone, acetone, methyl acetate, ethyl acetate, ethyl lactate, acetonitrile, methylene chloride, chloroform, tetrachloroethane, and tetrahydrofuran (THF); inorganic salts such as sodium hydroxide, potassium hydroxide, calcium hydroxide, sodium carbonate, and potassium carbonate; amines such as triethylamine; alkaline solutions such as aqueous solutions or organic solvent solutions of alkalis such as ammonia; inorganic acids such as hydrogen chloride, sulfuric acid, and nitric acid; acidic solutions such as aqueous solutions or organic solvent solutions of acids, where the acids are exemplified by carboxy-containing organic acids such as acetic acid and phthalic acid; and mixtures of them.

The chemical-resistant polymer may have excellent resistance to any of chemicals such as highly polar solvents, alkalis, and acids. The chemical-resistant polymer is exemplified by thermosetting resins and photo-curable resins, such as phenolic resins, xylene resins, urea resins, melamine resins, benzoguanamine resins, benzoxazine resins, alkyd resins, triazine resins, furan resins, unsaturated polyesters, epoxy resins, silicon resins, polyurethane resins, and polyimide resins; and thermoplastic resins such as poly(vinyl alcohols, cellulose acetate resins, polypropylene resins, fluorocarbon resins, phthalic acid resins, maleic acid resins, saturated polyesters, ethylene-vinyl alcohol copolymers, chitins, and chitosans. Each of different polymers may be used alone or in combination as the chemical-resistant polymer. The chemical-resistant polymer may also be selected from copolymers and graft polymers.

In the embodiment, the microporous laminated membrane includes the microporous membrane coated with such chemical-resistant polymer. Assume that this microporous laminated membrane is in contact with one of the chemicals such as highly polar solvents, alkalis, and acids. Even in this case, the microporous laminated membrane can resist deterioration such as dissolution or swelling/deformation of the microporous membrane, where the deterioration is restrained fully or to such an extent as not to adversely affect the purpose or intended use. Typically, assume that the microporous laminated membrane is used in a use in which the microporous membrane is in contact with the chemical within a short time. In this case, the microporous laminated membrane has only to be imparted with such chemical resistance as to resist deterioration over the time.

Most of the chemical-resistant polymers also have heat resistance. In these cases, the microporous laminated membrane may less possibly suffer from inferior heat resistance as compared with a microporous laminated membrane in which the microporous membrane is not coated with the chemical-resistant polymer.

The micropores constituting the microporous membrane may be charged with a functional material. The functional material is exemplified by fine ferrite particles and other fine metal particles (including fine metal-containing particles such as fine metal oxide particles), carbon black, carbon nanotubes, fullerene, titanium oxide, and barium titanate.

The functional material may be charged preferably, but not limitatively, under such conditions as to be charged with a size on the order of from submicrons to microns. This is preferred because the resulting microporous membrane may resist deterioration or loss of pore properties which the microporous membrane inherently has. In addition, the microporous membrane (and the resulting microporous laminated membrane) can be handled and operated more satisfactorily, because the amount of the functional material to be charged can be easily adjusted. Assume that the functional material is charged into micropores of the microporous membrane. In this case, if the micropores have excessively small sizes, the functional material may be charged with difficulty. In contrast, if the micropores have excessively large sizes, the functional material may hardly be charged with a size controlled on the order of from submicrons to microns. To prevent these, the micropores preferably have an average pore diameter within the above-mentioned range and preferably have a maximum pore diameter of 15 μm or less in the membrane surface.

Combination of Nonwoven-Fabric Substrate and Microporous Membrane

For good adhesion between the nonwoven-fabric substrate and the microporous membrane, components to constitute the two layers are preferably selected so as to allow the two layers to have good adhesion (affinity) therebetween. Specifically, in a preferred embodiment, the microporous membrane includes at least one resin selected from the group consisting of polyimide resins, polyamide-imide resins, polyetherimide resins, polytetrafluoroethylene (PTFE) resins, and polyethersulfone resins; and the nonwoven-fabric substrate includes at least one nonwoven fabric selected from the group consisting of polyolefin nonwoven fabrics, polyester nonwoven fabrics, and polyamide nonwoven fabrics. In a more preferred embodiment, the nonwoven-fabric substrate includes at least one nonwoven fabric selected from the group consisting of bilayer nonwoven fabrics and multilayer nonwoven fabrics each including any of the above-mentioned nonwoven fabrics.

In a furthermore preferred embodiment, the microporous membrane includes at least one resin selected from the group consisting of polyimide resins, polyamide-imide resins, polyetherimide resins, and polyethersulfone resins; and the nonwoven-fabric substrate includes at least one nonwoven fabric selected from the group consisting of polyolefin nonwoven fabrics and polyester nonwoven fabrics. In a still more preferred embodiment, the nonwoven-fabric substrate includes at least one nonwoven fabric selected from the group consisting of bilayer nonwoven fabrics and multilayer nonwoven fabrics each including any of the above-mentioned nonwoven fabrics.

In another preferred embodiment, the microporous membrane includes at least one resin selected from the group consisting of polyimide resins, polyamide-imide resins, polyetherimide resins, and polyethersulfone resins; and the nonwoven-fabric substrate includes at least one nonwoven fabric selected from the group consisting of polyolefin nonwoven fabrics and polyester nonwoven fabrics. In a more preferred embodiment, the nonwoven-fabric substrate includes at least one nonwoven fabric selected from the group consisting of bilayer nonwoven fabrics each including any of these nonwoven fabrics.

In an embodiment, the microporous membrane includes the resin. In this embodiment, the microporous membrane may contain the resin in a content of typically from 80 to 100 percent by weight, preferably from 90 to 100 percent by weight, and more preferably from 95 to 100 percent by weight, based on the total amount of the microporous membrane.

In an embodiment, the nonwoven-fabric substrate includes the resin or fibers. In this embodiment, the nonwoven-fabric substrate may contain the resin or fibers in a content of typically from 60 to 100 percent by weight, preferably from 80 to 100 percent by weight, and more preferably from 90 to 100 percent by weight, based on the total amount of the nonwoven-fabric substrate.

Microporous Laminated Membrane

The microporous laminated membrane according to the embodiment of the present invention includes the nonwoven-fabric substrate and the microporous membrane structurally integrated with each other with excellent adhesion and has high mechanical strengths. Advantageously, the microporous laminated membrane can exhibit sufficient strength even when having a small thickness typically of less than 100 μm.

In a preferred embodiment, the microporous laminated membrane according to the present invention includes the nonwoven-fabric substrate and the microporous membrane on one or both entire surfaces. The microporous membrane has a multiplicity of interconnecting micropores, and the micropores have an average pore diameter of from 0.01 to 10 μm. The microporous membrane has a thickness of from 1 to 100 μm and a porosity of from 30% to 80%. The nonwoven-fabric substrate has a thickness of from 10 to 500 μm. The microporous laminated membrane according to the preferred embodiment may be produced by specifying materials, thicknesses, and production conditions for the microporous membrane and the substrate as appropriate.

The microporous laminated membrane has an air permeability of from 0.5 to 30 seconds, preferably from 0.5 to 20 seconds, more preferably from 0.5 to 10 seconds, and furthermore preferably from 0.5 to 5 seconds. The microporous laminated membrane, as having an air permeability within the range, can maintain satisfactory gas permeability and is useful typically as a gas or liquid filter, or a separator for cell or capacitor use. The air permeability of the microporous laminated membrane may be measured by a method described in the working examples in conformance with Japanese Industrial Standard (JIS) P 8117 using a Gurley densometer type B.

The microporous laminated membrane has a tensile strength of 4.0 N/15 mm or more, preferably 5.0 N/15 mm or more, more preferably 6.0 N/15 mm or more, and furthermore preferably 8.0 N/15 mm or more. The microporous laminated membrane, as having a tensile strength at a certain level or higher, can maintain its strength and flexibility and can be handled satisfactorily. The tensile strength of the microporous laminated membrane may be measured by a method described in the working examples using a universal tensile tester.

The microporous laminated membrane may have a rate of dimensional change of typically 5% or less, preferably 4% or less, and more preferably 3% or less as a result of a high-temperature exposure test mentioned below. The microporous laminated membrane, when having a rate of dimensional change within the range, can maintain its shape (dimensions) even at high temperatures, hardly causes electrode short-circuit to provide better safety, and is useful typically as a cell or capacitor separator.

High-Temperature Exposure Test

The laminated membrane integrally including the substrate and the microporous membrane is trimmed to give an approximately rectangular specimen having a width of about 5 cm and a length of about 10 cm. The lengths a1 and b1 of two perpendicular sides of the approximately rectangular specimen are measured, the specimen is placed and left stand in a thermostat controlled at 140° C. for 30 minutes, retrieved from the thermostat, left stand to cool down to room temperature, thereafter the lengths a2 and b2 of the two perpendicular sides of the approximately rectangular specimen are measured. Rates of dimensional change between a1 and a2 and between b1 and b2 are determined according to formulae below. The rates of dimensional change are averaged, and the average is defined as the rate of dimensional change in the high-temperature exposure test. The formulae are expressed as follows:

Rate(%) of dimensional change between a1 and a2={|a2−a1|/a1}×100; and

Rate(%) of dimensional change between b1 and b2={|b2−b1|/b1}×100.

The microporous laminated membrane according to the embodiment of the present invention has only to include the substrate and the microporous membrane, where the microporous membrane is disposed on at least one side of the substrate. The microporous laminated membrane may include the microporous membranes disposed on both sides of the substrate. The microporous membrane may be charged with a functional material. When the microporous laminated membrane includes two or more microporous membranes, the two or more microporous membranes may be charged with identical or different functional materials.

In an embodiment, the microporous laminated membrane according to the present invention utilizes the pore properties of the microporous membrane as intact or after functionalizing the micropores with a functional material. This microporous laminated membrane is useful as any of filters, separation membranes, and separators, or as part of them.

In addition, the microporous laminated membrane according to the embodiment of the present invention may have undergone a heat treatment and/or a coating treatment as needed so as to impart a desired property.

The microporous laminated membrane according to the embodiment of the present invention has the configuration and is applicable to a wide variety of uses in wide areas. In particular, the microporous laminated membrane is suitably usable as a filter, a separation membrane, or a separator, or part thereof. Typically, the microporous laminated membrane is useable as a liquid separation membrane, a solid separation membrane, or a gas separation membrane, or part thereof.

Specifically, the microporous laminated membrane is suitable typically as or for bag filters, dust collector filters, filters for air conditioning equipment, and automotive filters (e.g., air cleaners, oil cleaners, indoor air cleaning filters, and engine intake air filters).

In addition, the microporous laminated membrane is also usable as a wide variety of base materials for circuit boards, heat-radiating members (e.g., heat sinks and heat slingers), battery separators, electromagnetic wave control materials (e.g., electromagnetic shielding materials and electromagnetic wave absorbers), electrolytic capacitors, low-dielectric constant materials, cushioning materials, ink image receiving sheets, test papers, insulating materials, heat insulators, cell culture substrata, radiation shielding mat materials, and oil absorbent materials.

It has been considered that a nonwoven fabric itself is usable as a filter, separation membrane, or separator. However, the nonwoven fabric has a pore diameter of at least several tens of micrometers or more and fails to collect or trap fine substances.

In contrast, the microporous laminated membrane according to the embodiment of the present invention is advantageously usable as any of filters, separation membranes, and separators. The nonwoven-fabric substrate, as bearing the microporous membrane, can surely have sufficient strength. The microporous laminated membrane may possibly expand its use even to uses where a microporous membrane by itself fails to have sufficient strength because of high porosity of the microporous membrane. In an embodiment, the microporous laminated membrane according to the present invention may be used in a filter. The filter is exemplified by filters for filtration of liquids such as water, aqueous solutions, and solvents, and for filtration of gases such as air; filters for waste water treatment so as to remove foreign substances of a size on the order of submicrons or more; filters for filtration typically of blood to separate erythrocytes; and air conditioner filters to separate substances such as dust, pollen, fungi, and dead mites. The microporous laminated membrane according to the embodiment of the present invention is also usable as oxygen enriching membrane substrates for use in air conditioners.

In addition, the microporous laminated membrane may be used typically as ink-jet printer filters. Ink-jet printers employ a variety of filters depending on the purpose, so as to discharge an ink from a fine orifice of an ink-jet head stably without plugging. While being available in names varying from manufacturer to manufacturer, the filters are exemplified by capsule filters, ink charger filters, bulk filters, Last Chance Filters for printer head protection, ink damper (filter damper) filters, bubble-suppressing filters, and in-line filters.

The microporous laminated membrane may also be used as or in medical-use filters. In the medical field, liquid nitrogen or another similar substance is used for cryopreservation of blood, germ cells (sperms and ova), cultured cells, and biological samples or materials. The liquid nitrogen and similar substances for use in this use should be cleaned from foreign substances such as viruses. Such viruses generally have a size of from about 0.1 to about 0.2 μm. The microporous laminated membrane according to the embodiment of the present invention, when used to filter the liquid nitrogen therethrough, can remove such viruses from the liquid nitrogen.

The microporous laminated membrane according to the embodiment of the present invention is also usable as test papers. The test papers are widely used typically in experimental uses and medical uses and are exemplified by pH indicator papers (e.g., litmus papers), water quality test papers (e.g., ion test papers), oil test papers, moisture indicator papers, ozone papers, urine test papers, and blood test papers. The ion test papers enable qualitative or quantitative examination of metal ions and/or anions. The urine test papers enable quantitative examination typically of urinary sugar, urinary protein, and/or urinary occult blood. The blood test papers enable quantitative examination typically of blood glucose level. These test papers enable easy and simple measurements, and their use opportunities or frequencies grow year after year.

The microporous laminated membrane according to the embodiment of the present invention includes the substrate and the microporous membrane in intimate contact with each other and can surely offer sufficient strength upon handling. The microporous laminated membrane is usable as a preferred medium because the microporous membrane can adsorb an indicator to be used in examination or evaluation. In addition, the microporous laminated membrane can retain a solvent (e.g., water) or a sample (e.g., urine or blood) and is advantageous for use in these applications.

The microporous laminated membrane according to the embodiment of the present invention is also preferably usable as battery separators. Such battery separators should separate a cathode from an anode, satisfactorily hold an electrolyte, and have good ionic conductivity. In addition, the battery separators require various properties such as heat resistance, flexibility, and strength. The microporous laminated membrane according to the embodiment of the present invention can exhibit these properties in good balance and is extremely useful as separators for a variety of batteries or cells.

The battery separators require high heat resistance due to past ignition accidents lessons and for better safety in automotive or industrial uses. The microporous laminated membrane according to the embodiment of the present invention is useful also in this respect.

In an embodiment, the microporous laminated membrane according to the present invention may employ a water-resistant (water-proof) nonwoven fabric as the substrate. The microporous laminated membrane in this embodiment does not approximately suffer from swelling of the nonwoven-fabric substrate.

### Method for Producing Microporous Laminated Membrane

The microporous laminated membrane according to the embodiment of the present invention may be produced typically by a method as follows. In the method, the microporous membrane and the nonwoven-fabric substrate are independently prepared, and the microporous membrane is disposed on at least one side of the nonwoven-fabric substrate typically by thermal fusion bonding. The microporous membrane may be prepared typically by casting a polymer solution onto a film backing to give a membrane, and the membrane on the film backing is brought into contact with a coagulation liquid and thereby subjected to a pore-making process. The production will be illustrated in detail below.

Microporous Membrane Production Method

The microporous membrane may be prepared typically by a method including the step of casting a polymer solution onto a film backing to form a membrane. The membrane on the film backing is then brought into contact with a coagulation liquid to undergo a pore-making process, then separated from the film backing, dried, and yields the microporous membrane. The way to bring the membrane into contact with a coagulation liquid to make pores in the membrane is exemplified by known techniques such as film formation by a wet phase inversion technique (see, e.g., JP-A No. 2001-145826), film formation by a dry phase inversion technique (see, e.g., PCT International Publication Number WO 98/25997), and a technique using a solvent substitution rate-controlling material (see, e.g., JP-A No. 2000-319442 and JP-A No. 2001-67643).

The microporous membrane may also be prepared by any of production methods for resinous microporous membranes represented by polyolefin microporous membranes. The production methods for resinous microporous membranes are roughly classified into two methods, i.e., a wet method and a dry method. In the wet method, pores are made in an extraction process. In the dry method, pores are made in a stretching process. The dry method is exemplified by a method described in JP-A No. S58-59072. JP-A No. S58-59072 discloses a production method in which a resin and an agent such as a plasticizer are kneaded, melted, and extruded to give an extrudate, and the agent such as a plasticizer is extracted in an extractor to thereby make pores in the extrudate.

The dry method is exemplified by a method described in JP-A No. S62-121737. JP-A No. S62-121737 discloses a production method in which an original membrane is formed by melt-extrusion, allowed to bear crystal lamellae, subjected to longitudinal uniaxial stretching to cleave between the crystal lamellae to thereby make the membrane porous. The method stands in no need of the extraction process unlike the wet method and can employ simplified processes. In addition, PCT International Publication Number WO 2007/098339 discloses a method for producing a biaxially-stretched microporous membrane by the dry method. Specifically, PCT International Publication Number WO 2007/098339 discloses a technique in which a microporous membrane is prepared by a known longitudinal uniaxial stretching technique and then transversely stretched while relaxing longitudinally in hot process.

The polytetrafluoroethylene (PTFE) microporous membranes may also be prepared by a method as with the polyolefin microporous membranes.

The polymer solution to be subjected to casting may for example be a solution mixture including a polymer component, a water-soluble polymer, a water-miscible polar solvent, and, as needed, water, where the polymer component acts as a material to constitute the microporous membrane.

The polymer component acting as a material to constitute the microporous membrane is preferably one that is soluble in the water-miscible polar solvent and can form a film or membrane by phase inversion. The solution mixture may include each of different polymer components as mentioned above alone or in combination. The polymer solution may also include, instead of the polymer component to constitute the microporous membrane, any of a monomer component (starting material) to form the polymer component, an oligomer of such monomer component, and a precursor for the polymer component before a process such as imidization or cyclization.

The water-soluble polymer and/or water, when added to the polymer solution to be subjected to casting, is effective to allow the membrane to have a spongy and porous structure. The water-soluble polymer is exemplified by polyethylene glycols, polyvinylpyrrolidones, poly(ethylene oxide)s, poly(vinyl alcohols, poly(acrylic acid)s, polysaccharides, derivatives thereof, and mixtures of them. Among them, polyvinylpyrrolidones are preferred because they resist the formation of voids in the membrane and allow the membrane to have higher mechanical strength. The polymer solution may include each of different water-soluble polymers alone or in combination. For making micropores satisfactorily, the water-soluble polymer may have a molecular weight of desirably 200 or more, preferably 300 or more, and particularly preferably 400 or more (typically from about 400 to about 200000). In particular, the water-soluble polymer may have a molecular weight of 1000 or more. The void diameter (pore diameter) of the microporous membrane may be adjusted by the addition of water to the polymer solution. Typically, the microporous membrane can have voids (pores) with larger void (pore) diameters when adding water in a larger amount to the polymer solution.

The water-soluble polymer is very effective to allow the membrane to have a spongy structure, and the microporous membrane can have a wide variety of structure by changing the type and amount (proportion) of the water-soluble polymer. The water-soluble polymer is extremely advantageously usable as an additive for the formation of a microporous membrane so as to impart desired pore properties to the microporous membrane. In contrast, the water-soluble polymer is a component that does not ultimately constitute the microporous membrane and is to be removed as an unnecessary component. In a method using the wet phase inversion technique, the water-soluble polymer can be easily washed away and removed in a process of immersing the article in a coagulation liquid such as water to undergo phase inversion. In contrast, in the dry phase inversion technique, components (unnecessary components) not constituting the microporous membrane are removed by heating, and it is not so easy to remove the water-soluble polymer by heating as compared with the method using the wet phase inversion technique. The production method using the wet phase inversion technique can produce the microporous membrane having desired pore properties more easily as compared with the production method using the dry phase inversion technique.

The water-miscible polar solvent is exemplified by dimethyl sulfoxide, N,N-dimethylformamide, N,N-dimethylacetamide (DMAc), N-methyl-2-pyrrolidone (NMP), 2-pyrrolidone, and mixtures of them. The water-miscible polar solvent may be selected depending typically on the chemical skeleton of a resin used as the polymer component, as one having solubility for the resin (good solvent for the polymer component).

The polymer solution to be subjected to casting is typically preferably a solution mixture including 8 to 25 percent by weight of the polymer component, 5 to 50 percent by weight of the water-soluble polymer, 0 to 10 percent by weight of water, and 30 to 82 percent by weight of the water-miscible polar solvent, where the polymer component acts as a material to constitute the microporous membrane (porous film). The polymer solution, if containing the polymer component in an excessively low concentration, may cause the microporous membrane to have, with difficulty, an insufficient thickness and/or to have desired pore properties. In contrast, the polymer solution, if containing the polymer component in an excessively high concentration, may tend to cause the microporous membrane to have a lower porosity. The water-soluble polymer is added so as to allow the membrane to have a uniform spongy porous structure inside of the membrane. The polymer solution, if containing the water-soluble polymer in an excessively low concentration, may cause huge voids with a size typically of greater than 10 μm and may cause the microporous membrane to have inferior uniformity. The polymer solution, if containing the water-soluble polymer in an excessively high concentration, may suffer from inferior solubility of the water-soluble polymer. In particular, the polymer solution, if containing the water-soluble polymer in a high concentration of greater than 50 percent by weight, may cause the membrane to suffer from disadvantages such as low membrane strength. The void diameters may be adjusted by regulating the amount of water to be added. Typically, the voids (pores) may have larger diameters by adding a larger amount of water.

In a preferred embodiment upon casting of the polymer solution into a film (membrane), the membrane is held in an atmosphere at a temperature of from 15° C. to 90° C. and relative humidity of from 70% to 100% for 0.2 to 15 minutes and then brought into a coagulation liquid including a non-solvent for the polymer component. The membrane (film-like article) after casting, when held under the conditions, may allow the resulting microporous membrane to be uniform and to have high interconnectivity. This is probably because the membrane, when held at high humidity, may allow water to migrate from the membrane surface into the inside of the membrane and to efficiently promote the phase separation of the polymer solution. The membrane is held more preferably at a temperature of from 30° C. to 80° C. and relative humidity of from 90% to 100%, and particularly preferably at a temperature of from 40° C. to 70° C. and relative humidity of about 100% (typically from 95% to 100%). The membrane, when held at a moisture content in the air (relative humidity) less than the range, may disadvantageously cause the microporous membrane to have an insufficient surface opening area rate.

The microporous membrane production method enables easy formation typically of a microporous membrane including a multiplicity of interconnecting micropores, where the micropores have an average pore diameter of from 0.01 to 10 μm. The microporous membrane constituting the microporous laminated membrane according to the embodiment of the present invention can have desired micropore diameter, porosity, and rate of opening area as adjusted by appropriately selecting the types and amounts of components of the polymer solution, the amount of water to be used, and the humidity, temperature, and time of casting, as has been described above.

The coagulation liquid for use in the phase inversion is not limited, as long as being a solvent that coagulates the polymer component and may be selected as appropriate depending on the type of a polymer used as the polymer component. Typically, the coagulation liquid may be a solvent that coagulates a polyamide-imide resin or polyamic acid and is exemplified by water-soluble or water-miscible coagulation liquids including water; alcohols such as monohydric alcohols (e.g., methanol and ethanol) and polyhydric alcohols (e.g., glycerol); water-soluble polymers such as polyethylene glycols; and mixtures of them.

In the microporous membrane production method, the polymer solution is cast as a membrane on a film backing, the cast membrane on the film backing is brought into the coagulation liquid to form a microporous membrane on the film backing, the microporous membrane is separated (peeled) from the film backing, and dried as intact to give the microporous membrane. The drying process may be performed by any technique that can remove the solvent component such as the coagulation liquid and may be performed with heating or by air drying at room temperature. The way to perform heating is not limited, as long as being one that can control the microporous membrane at a predetermined temperature, and is exemplified by hot air treatment, hot roll treatment, and placing the microporous membrane typically in a thermostat or an oven. The heating may be performed at a temperature selectable within a wide range of typically from room temperature to about 600° C. The heating may be performed in any atmosphere such as air, nitrogen, and inert gas atmospheres. Heating in an air atmosphere is performed most inexpensively, but this may possibly involve an oxidation reaction. To prevent this, the heating may be performed in a nitrogen or another inert gas atmosphere, of which the nitrogen atmosphere is preferred in view of cost. The heating may be performed under conditions determined as appropriate in consideration typically of productivity and properties of the microporous membrane. The drying gives the microporous membrane for use herein.

The resulting microporous membrane may further be subjected to a crosslinking treatment with any of heat, visible light, ultraviolet rays, electron beams, and radioactive rays (radiation). The treatment may allow the polymerization, crosslinking, and/or curing of a precursor constituting the microporous membrane to form a polymer. Alternatively, when the microporous membrane before the treatment includes a polymer, the treatment allows the crosslinking and/or curing of the polymer. Thus, the treatment allows the resulting microporous membrane to have still better properties such as rigidity and chemical resistance. For example, a microporous membrane formed from a polyimide precursor, when subjected typically to thermal or chemical imidization, can give a polyimide microporous membrane. A microporous membrane formed from a polyamide-imide resin may be subjected to thermal crosslinking. The thermal crosslinking may be performed simultaneously with the heating for drying after the membrane is brought into the coagulation liquid.

Lamination of Nonwoven-Fabric Substrate and Microporous Membrane

The nonwoven-fabric substrate and the microporous membrane can be reasonably laminated with each other typically by thermal fusion bonding (heat sealing) to give the microporous laminated membrane. Assume that the microporous membrane includes a first resin, and the nonwoven fabric includes a second resin. In this case, the first resin preferably has a glass transition temperature higher than the melting point of the second resin.

Specifically, the microporous laminated membrane may be produced by a method as follows. In the method, the microporous membrane is disposed on at least one side of the nonwoven-fabric substrate, the resulting article is heated from the microporous membrane side or from both sides with a heat source to slightly melt or fuse the surface of the nonwoven-fabric substrate in contact with the microporous membrane to thereby yield a laminated membrane including the nonwoven-fabric substrate and the microporous membrane in intimate contact with each other. This process is preferably performed while placing a protective film on or both sides of the laminate so as to protect the microporous membrane or the nonwoven-fabric substrate, or both, typically from friction. The heat source for use herein is exemplified by an electric iron, laminator, and heating roller. The heating may also be performed using an apparatus such as a laminating machine, heat sealer, calendering equipment, or roller press machine.

The first resin constituting the microporous membrane preferably has a glass transition temperature higher than the second resin constituting the nonwoven fabric. This is preferred so as to slightly melt the nonwoven-fabric substrate alone while the heat does not or little affect the microporous membrane including the micropores. The heating has only to be performed to such an extent that the nonwoven fabric is melted and becomes in intimate contact with the microporous membrane. Heating more than necessary may cause clogging of pores (voids) of the nonwoven fabric and is not preferred. The heating temperature is preferably determined between the glass transition temperature of the first resin constituting the microporous membrane and the melting point of the second resin constituting the nonwoven fabric inclusive. The heating temperature is preferably lower than the glass transition temperature of the first resin constituting the microporous membrane and equal to or higher than the melting point of the second resin constituting the nonwoven fabric. As used herein the term “heating temperature” refers to a temperature of a portion at which the microporous membrane and the nonwoven-fabric substrate are in contact with each other. Typically, assume that a polyolefin such as a polyethylene or polypropylene is used to form the nonwoven fabric. In this case, the heating temperature may be from about 140° C. to about 170° C., because the polyolefin generally has a melting point of from about 130° C. to about 165° C.

General nonwoven fabrics have an air permeability of equal to or less than the limit of measurement, i.e., equal to or less than 0.1 second. The polyolefin nonwoven fabric, even when thermally partially deformed as a result of thermal fusion bonding, little affects the air permeability of the microporous laminated membrane. However, it is not preferred to hold the laminate at a temperature equal to or higher than the melting point of the second resin constituting the nonwoven fabric for a long period of time. The thermal fusion bonding may be controlled by technical factors such as heating temperature, heat source traveling speed, and pressure. Appropriate control of these factors is important.

In a preferred embodiment, the microporous laminated membrane may be produced by a method as follows. In the method, the microporous membrane is prepared by casting the polymer solution to give a film (membrane) on a backing, the membrane on the backing is brought into a coagulation liquid, the resulting membrane is separated from the backing and dried. Separately, the nonwoven-fabric substrate is prepared. The microporous membrane is laminated with the nonwoven-fabric substrate typically by thermal fusion bonding. In this method, the microporous membrane includes a first resin, and the nonwoven fabric includes a second resin. In this preferred embodiment, the first resin has a glass transition temperature higher than the melting point of the second resin.

This method can give a microporous laminated membrane including the microporous membrane directly laminated with the substrate, where the microporous membrane has excellent pore properties.

The method for producing a microporous laminated membrane can easily give a laminated membrane including the substrate and, on one or both sides thereof, the microporous membrane. In the laminated membrane, the microporous membrane includes a multiplicity of interconnecting micropores, and the micropores have an average pore diameter of from 0.01 to 10 μm.

### EXAMPLES

The present invention will be illustrated in further detail with reference to several examples below. It should be noted, however, that the examples are by no means intended to limit the scope of the present invention. The tape peel test, average pore diameter measurement, microporous membrane average internal porosity (pore content) measurement, air permeability test, high-temperature exposure test, arithmetic mean surface roughness Sa (surface roughness) measurement, and tensile strength measurement were performed by methods as follows.

Tape Peel Test

(i) A sample microporous laminated membrane is applied with an after-mentioned tape on the microporous membrane surface, and an after-mentioned roller is moved along a portion to be bonded to compression-bond the tape with the microporous laminated membrane.

(ii) The resulting article is subjected to T-peel using an after-mentioned universal tensile tester at a peel rate of 50 mm/min.

(iii) Whether the microporous membrane and the nonwoven-fabric substrate undergo interfacial peeling is observed.

Tape: Film Masking Tape No. 603 (#25) (trade name), 24 mm wide, supplied by Teraoka Seisakusho Co., Ltd.

Roller: Diameter 30 mm, 200 gf load

Universal tensile tester: TENSILON RTA-500 (trade name), supplied by ORIENTEC Co., Ltd.

The average pore diameter and porosity of the membrane prepared in Example 1 were calculated by methods below. The average pore diameter and porosity were determined for micropores that were seen frontmost in an electron photomicrograph, but not for micropores that were seen at the back of the electron photomicrograph.

Average Pore Diameter Measurement

Areas of micropores at 30 or more points in a surface or cross-section of a sample laminated membrane were measured based on an electron photomicrograph, the areas were averaged, and the average was defined as an average pore area Sₐᵥₑ. Assuming that the pores are perfect circles, the average pore area was converted into a pore diameter by a formula below, and the pore diameter was defined as the average pore diameter. The formula is expressed as follows:

Surface or internal average pore diameter [μm]=2×(Sₐᵥₑ/π)^{1/2}

where π represents the ratio of the circumference of a circle to its diameter.

Microporous Membrane Average Internal Porosity (Pore Content) Measurement

In a microporous laminated membrane prepared in Comparative Example 1, a microporous membrane made its way into a nonwoven fabric and was integrated with the nonwoven-fabric substrate. This impedes the measurement of internal porosity of the microporous membrane. To avoid this, the measurement of internal porosity in the microporous membrane was performed in the following manner. A poly(ethylene terephthalate) (PET) film was used as a substrate instead of a PET nonwoven fabric. The PET film was a product under the trade name of HS74AS supplied by DuPont Teijin Films, Ltd. and had a thickness of 100 μm. A polymer solution (membrane-forming solution) was cast onto a good-adhesion surface of the PET film, immersed in water to coagulate the solution to form a membrane, the membrane was separated from the PET film and dried to give a microporous membrane as a porous film. The resulting microporous membrane was subjected to measurements of volume and weight, based on which the internal porosity was calculated according to a formula as follows. The internal porosity of a sample including no substrate was calculated as intact. The formula is expressed as follows:

Porosity[%]=100−100×W/(ρ×V)

where V represents the volume [cm³] of the microporous membrane; W represents the weight [g] of the microporous membrane; and ρ represents the density [g/cm³] of a material constituting the microporous membrane. In the calculation, a polyamide-imide and a polyetherimide were defined respectively to have densities of 1.45 [g/cm³] and 1.27 [g/cm³].

Air Permeability Test

The air permeability was measured using a Gurley densometer type B supplied by TESTER SANGYO CO., LTD. in conformance with JIS P 8117. The Gurley time in seconds was measured using a digital auto-counter. A microporous membrane having a lower air permeability (Gurley permeability) refers to that the microporous membrane has higher gas permeability, i.e., the microporous membrane includes micropores with higher interconnectivity. The air permeabilities of a substrate and a microporous laminated membrane were evaluated by this testing method, unless otherwise specified.

High-Temperature Exposure Test

A sample laminated membrane integrally including a substrate and a microporous membrane was trimmed into an approximately rectangular specimen of about 5 cm wide by about 10 cm long, and dimensions (lengths) of perpendicular two sides “a” and “b” were measured to evaluate the dimensional change of the sample. First, initial dimensions (initial lengths) a1 and b1 of the two sides were measured. Next, the sample was placed and left stand in a thermostat controlled in temperature at 140° C. for 30 minutes. The sample was then retrieved from the thermostat, left stand to cool down to room temperature, and dimensions a2 and b2 of the two sides “a” and “b” were measured. The rates of dimensional change in the sides “a” and “b” were calculated by the formulae:

Rate(%) of dimensional change in side “a” after high-temperature exposure={|a2−a1|/a1}×100

Rate(%) of dimensional change in side “b” after high-temperature exposure={|b2−b1|/b1}×100

Arithmetic Mean Surface Roughness Sa (Surface Roughness) Measurement

The surface profile of a sample was measured by optical interferometry using Non-contact Surface Measurement System VertScan 2.0 (Ryoka Systems Inc.) and based on the result, the surface roughness was calculated. The measurement was performed in an area of 250 μm by 188 μm, at an objective lens magnification of 50-fold, at a lens barrel size of 0.5 time the body length, using a no-relay zoom lens and a 530 White wavelength filter in a wave measurement mode in a field of view with a size of 640 μm by 480 μm. The surface roughness employed herein was an arithmetic mean surface roughness (Sa).

Tensile Strength Measurement

A test specimen of a size of 15 mm wide by 150 mm long was sampled from a sample microporous laminated membrane in the machine direction (MD) (flow direction) in the preparation of the sample. The test specimen was pulled at a chuck-to-chuck distance of 100 mm and at a tensile speed of about 200 mm per minute using a universal tensile tester to measure its tensile strength. The measurements are indicated in newtons per 15 mm (N/15 mm).

### Production Example 1

To 100 parts by weight of a polyamide-imide resin solution, were added 35 parts by weight of a polyvinylpyrrolidone (having a molecular weight of 55000) as a water-soluble polymer and yielded a membrane-forming solution. The polyamide-imide resin solution was a product under the trade name of VYLOMAX HR11NN (Toyobo Co. Ltd.) having a solids concentration of 15 percent by weight and a solution viscosity of 20 dPa·s at 25° C. and using NMP as a solvent. Separately, a PET film serving as a backing was prepared as a product under the trade name of HS74AS (DuPont Teijin Films, Ltd.) having a thickness of 100 μm. The PET film was placed on a glass plate so that a good-adhesion surface of the film faced upward. The membrane-forming solution held at 25° C. was cast onto the PET film using a film applicator. The casting was performed with a 51-μm gap between the film applicator and the PET film. Immediately after casting, the resulting article was placed and held in a container at a temperature of 50° C. and humidity of about 100% for 4 minutes. The article was then immersed in water for coagulation and cleaning. During this process, a microporous membrane was spontaneously peeled off from the PET film.

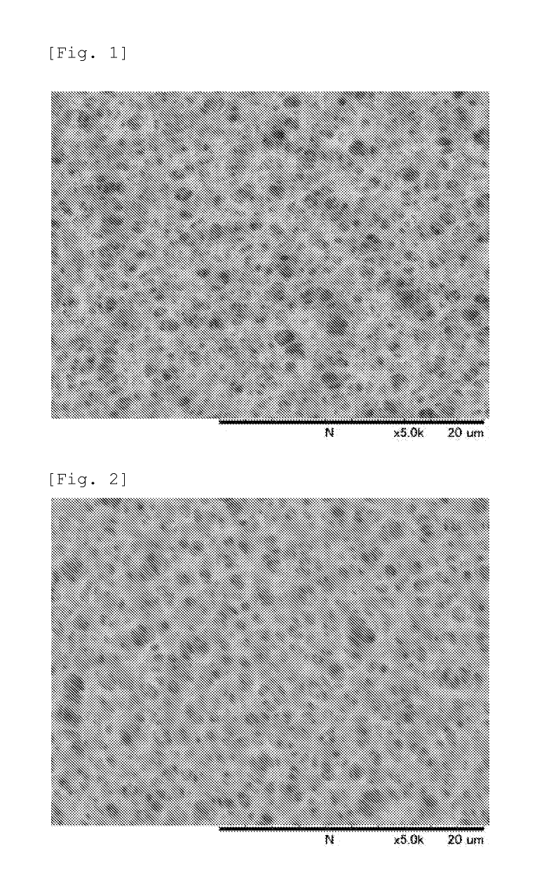

The microporous membrane was air-dried at room temperature and yielded a target microporous membrane. The resulting microporous membrane had a thickness of about 23 μm. The microporous membrane was observed with an electron microscope to find that the microporous membrane had micropores having an average pore diameter of about 0.5 μm in its surface; and the microporous membrane included interconnecting approximately uniform micropores all over the inside of the membrane, where the micropores had an average pore diameter of about 0.5 μm. The microporous membrane had an internal porosity of 70%. The microporous membrane was subjected to the air permeability measurement and found to have an average air permeability of 4 seconds, where three measurements were each 4 seconds. FIG. 1 depicts an electron photomicrograph (SEM photomicrograph) of the surface of the microporous membrane prepared in Production Example 1.

### Production Example 2

To 100 parts by weight of a polyetherimide resin solution, were added 30 parts by weight of a polyvinylpyrrolidone (having a molecular weight of 55000) as a water-soluble polymer and yielded a membrane-forming solution. The polyetherimide resin solution was a product under the trade name of ULTEM 1000P (Innovative Plastics Japan LLC (SABIC)) having a solids concentration of 18 percent by weight and using NMP as a solvent.

Separately, a PET film serving as a backing was prepared as a product under the trade name of HS74AS (DuPont Teijin Films, Ltd.) having a thickness of 100 μm. The PET film was placed on a glass plate so that the good-adhesion surface of the film faced upward. The membrane-forming solution held at 25° C. was cast onto the PET film using a film applicator. The casting was performed with a 51-μm gap between the film applicator and the PET film. Immediately after casting, the resulting article was placed and held in a container at a temperature of 50° C. and humidity of about 100% for 4 minutes. The article was then immersed in water for coagulation and cleaning. During this process, a microporous membrane was spontaneously peeled off from the PET film. The microporous membrane was air-dried at room temperature and yielded a target microporous membrane. The resulting microporous membrane had a thickness of about 24 μm. The microporous membrane was observed with an electron microscope to find that the microporous membrane had micropores having an average pore diameter of about 1 μm in its surface; and the microporous membrane included interconnecting approximately uniform micropores all over the inside of the membrane, where the micropores had an average pore diameter of about 1 μm. The microporous membrane had an internal porosity of 73%. The microporous membrane was subjected to the air permeability measurement and found to have an average air permeability of 4 seconds, where three measurements were 3, 4, and 4 seconds. FIG. 2 depicts an electron photomicrograph (SEM photomicrograph) of the surface of the microporous membrane prepared in Production Example 2.

### Example 1

A polyolefin nonwoven fabric was prepared as a product under the trade name of FT-330N (Japan Vilene Co., Ltd.). This had a thickness of about 250 μm, a mass per unit area of about 80 g/m², a density of about 0.36 g/cm³, and an air permeability of 0.1 second. Independently, a PET film was prepared as a product under the product name of LUMIRROR S10 (Toray Industries Inc.) having a thickness of 100 μm. The PET film was folded into two leaves. The polyamide-imide microporous membrane prepared in Production Example 1 was laid on the polyolefin nonwoven fabric to give a laminate, and the laminate was disposed between the two leaves of the folded PET film and placed on a desk. A steam iron (product number: NI-R70, supplied by Panasonic Corporation) was set in temperature of “Middle” (about 150° C.) and, in a state where the iron temperature reached the preset temperature, used to heat the resulting article including the PET film from the polyamide-imide microporous membrane side. The steam iron traveled at a speed of about 60 cm/min.

The method gave a laminated membrane integrally including the polyamide-imide microporous membrane and the polyolefin nonwoven fabric. The laminated membrane had a total thickness of about 313 μm. The laminated membrane underwent no change in the polyamide-imide microporous membrane surface because the polyamide-imide has a glass transition temperature of about 300° C.

The prepared laminated membrane was subjected to the tape peel test and found to undergo no interfacial peeling between the nonwoven fabric and the microporous membrane. The laminated membrane was observed with an electron microscope and found to have an average pore diameter of micropores of about 0.5 μm, where the micropores were present in the surface of the microporous membrane. The laminated membrane was subjected to the air permeability measurement and found to have an average air permeability of 4 seconds which is identical to that of the polyamide-imide microporous membrane before lamination, where three measurements were 4, 5, and 4 seconds. The laminated membrane suffered from no lamination-induced deterioration and little variation in gas permeability.

The laminated membrane had rates of dimensional change in the sides “a” and “b” of each 1.0% after the high-temperature exposure and suffered from little dimensional changes caused by the high-temperature exposure. The results demonstrate that the laminated membrane had excellent dimensional stability (shape stability) at high temperatures.

### Example 2

A polyolefin nonwoven fabric was prepared as a product under the trade name of FT-330N (Japan Vilene Co., Ltd.). This had a thickness of about 250 μm, a mass per unit area of about 80 g/m², a density of about 0.36 g/cm³, and an air permeability of 0.1 second. Independently, a polyimide (PI) film was prepared as a product under the product name of Kapton 100H (DuPont-Toray Co., Ltd.) having a thickness of 25 μm. The PI film was folded into two leaves. The polyamide-imide microporous membrane prepared in Production Example 1 was laid on the polyolefin nonwoven fabric, and this was disposed between the two leaves of the folded PI film. A laminator (product number: LFA341D, supplied by IRISOHYAMA INC.) was set in temperature to a scale of 13 (about 150° C.) and, in a state where the laminator temperature reached the preset temperature, used to heat the resulting article including the PI film from both sides of the article. The laminator performed lamination at a speed of about 47 cm/min.

The method gave a laminated membrane integrally including the polyamide-imide microporous membrane and the polyolefin nonwoven fabric. The laminated membrane had a total thickness of about 249 μm. As being heated from the both sides, the surface of the polyolefin nonwoven fabric was slightly thermally melted to have higher smoothness. In contrast, the laminated membrane underwent no change in the polyamide-imide microporous membrane surface because the polyamide-imide has a glass transition temperature of about 300° C.

The prepared laminated membrane was subjected to the tape peel test and found to undergo no interfacial peeling between the nonwoven fabric and the microporous membrane. The laminated membrane was observed with an electron microscope and found to have an average pore diameter of micropores of about 0.5 μm, where the micropores were present in the surface of the microporous membrane. The laminated membrane was subjected to the air permeability measurement and found to have an average air permeability of 5 seconds, where three measurements were 5, 5, and 4 seconds. The measured values were approximately identical to those of the polyamide-imide microporous membrane before lamination and exhibited little variation. The laminated membrane was found to undergo no lamination-induced deterioration in gas permeability.

The laminated membrane had rates of dimensional change in the sides “a” and “b” respectively of 1.4% and 1.5% after the high-temperature exposure and suffered from little dimensional changes caused by the high-temperature exposure. The results demonstrate that the laminated membrane had excellent dimensional stability (shape stability) at high temperatures.

### Example 3

A laminated membrane integrally including a nonwoven fabric and a microporous membrane was prepared by the procedure of Example 2, except for preparing, as the nonwoven fabric, a bilayer nonwoven fabric including a polyester layer as one side and a polypropylene layer as the other side; and laying the polyamide-imide microporous membrane on the polypropylene side of the bilayer nonwoven fabric. The bilayer nonwoven fabric was a product under the trade name of 05EP-50 (Hirose Paper Mfg Co., Ltd.). This had a thickness of about 105 μm, a mass per unit area of about 50 g/m², a density of about 0.43 g/cm³, and an air permeability of 0.1 second. The resulting laminated membrane had a total thickness of about 135 μm. Although having been heated from both sides, the laminated membrane underwent no change in the polyester nonwoven fabric surface because the polyester has a melting point of about 260° C. In addition, the laminated membrane underwent no change in the polyamide-imide microporous membrane surface, because the polyamide-imide has a glass transition temperature of about 300° C.

The prepared laminated membrane was subjected to the tape peel test and found to undergo no interfacial peeling between the nonwoven fabric and the microporous membrane. The laminated membrane was observed with an electron microscope and found to have an average pore diameter of micropores of about 0.5 μm, where the micropores were present in the surface of the microporous membrane. The laminated membrane was subjected to the air permeability measurement and found to have an average air permeability of 4 seconds, where three measurements were each 4 seconds. The measured values were identical to those of the polyamide-imide microporous membrane before lamination and exhibited no variation. The laminated membrane was found to undergo no lamination-induced deterioration in gas permeability.

The laminated membrane had rates of dimensional change in the sides “a” and “b” respectively of 0% and 0.5% after the high-temperature exposure and suffered from little dimensional changes caused by the high-temperature exposure. The results demonstrate that the laminated membrane had excellent dimensional stability (shape stability) at high temperatures.

### Example 4

A laminated membrane integrally including a nonwoven fabric and a microporous membrane was prepared by the procedure of Example 2, except for preparing, as the nonwoven fabric, a bilayer nonwoven fabric including a polyester as one side and a polypropylene as the other side; and laying the polyamide-imide microporous membrane on the polypropylene side of the bilayer nonwoven fabric. The bilayer nonwoven fabric was a product under the trade name of 15EP-50 (Hirose Paper Mfg Co., Ltd.). This had a thickness of about 93 μm, a mass per unit area of about 50 g/m², a density of about 0.42 g/cm³, and an air permeability of 0.1 second. The resulting laminated membrane had a total thickness of about 131 μm. Although having been heated from both sides, the laminated membrane underwent no change in the polyester nonwoven fabric surface because the polyester has a melting point of about 260° C. In addition, the laminated membrane underwent no change in the polyamide-imide microporous membrane surface because the polyamide-imide has a glass transition temperature of about 300° C.

The prepared laminated membrane was subjected to the tape peel test and found to undergo no interfacial peeling between the nonwoven fabric and the microporous membrane. The laminated membrane was observed with an electron microscope and found to have an average pore diameter of micropores of about 0.5 μm, where the micropores were present in the surface of the microporous membrane. The laminated membrane was subjected to the air permeability measurement and found to have an average air permeability of 4 seconds, where three measurements were each 4 seconds. The measured values were identical to those of the polyamide-imide microporous membrane before lamination and exhibited no variation. The laminated membrane was found to undergo no lamination-induced deterioration in gas permeability.

The laminated membrane had rates of dimensional change in the sides “a” and “b” respectively of 0.4% and 0.5% after the high-temperature exposure and suffered from little dimensional changes caused by the high-temperature exposure. The results demonstrate that the laminated membrane had excellent dimensional stability (shape stability) at high temperatures.

### Example 5

A laminated membrane integrally including a polyamide-imide microporous membrane and a polyolefin nonwoven fabric was prepared by the procedure of Example 2, except for preparing, as the nonwoven fabric, a polyolefin nonwoven fabric as a product under the trade name of 06HOP-2 (Hirose Paper Mfg Co., Ltd.). This had a thickness of about 13 μm, a mass per unit area of about 2.6 g/m², a density of about 0.20 g/cm³, and an air permeability of 0.1 second. The resulting laminated membrane had a total thickness of about 38 μm. As having been heated from the both sides, the polyolefin nonwoven fabric surface was slightly thermally melted to have higher smoothness. In contrast, the laminated membrane underwent no change in the polyamide-imide microporous membrane surface because the polyamide-imide has a glass transition temperature of about 300° C.

The prepared laminated membrane was subjected to the tape peel test and found to undergo no interfacial peeling between the nonwoven fabric and the microporous membrane. The laminated membrane was observed with an electron microscope and found to have an average pore diameter of micropores of about 0.5 μm, where the micropores were present in the surface of the microporous membrane. The laminated membrane was subjected to the air permeability measurement and found to have an average air permeability of 5 seconds, where three measurements were 4, 4, and 5 seconds. The measured values were approximately identical to those of the polyamide-imide microporous membrane before lamination. The laminated membrane was found to undergo no lamination-induced deterioration in gas permeability.

The laminated membrane had rates of dimensional change in the sides “a” and “b” respectively of 1.6% and 0.7% after the high-temperature exposure. The laminated membrane underwent shape change of curling alone by the high-temperature exposure. The results demonstrate that the laminated membrane had excellent dimensional stability (shape stability) at high temperatures.

### Example 6

A laminated membrane integrally including a polyetherimide microporous membrane and a polyolefin nonwoven fabric was prepared by the procedure of Example 2, except for using, as the nonwoven fabric, a polyolefin nonwoven fabric as a product under the trade name of 06HOP-2 (Hirose Paper Mfg Co., Ltd.) and using, as the microporous membrane, the polyetherimide microporous membrane prepared in Production Example 2. The polyolefin nonwoven fabric had a thickness of about 13 μm, a mass per unit area of about 2.6 g/m², a density of about 0.20 g/cm³, and an air permeability of 0.1 second. The resulting laminated membrane had a total thickness of about 39 μm. As having been heated from the both sides, the laminated membrane under went slight thermal melting of the polyolefin nonwoven fabric surface to have higher smoothness. In contrast, the laminated membrane underwent no change in the polyetherimide microporous membrane surface because the polyetherimide has a glass transition temperature of about 217° C.

The prepared laminated membrane was subjected to the tape peel test and found to undergo no interfacial peeling between the nonwoven fabric and the microporous membrane. The laminated membrane was observed with an electron microscope and found to have having an average pore diameter of micropores of about 1 μm, where the micropores were present in the microporous membrane surface. The laminated membrane was subjected to the air permeability measurement and found to have an average air permeability of 4 seconds, where three measurements were 5, 4, and 3 seconds. The average air permeability was identical to that of the polyetherimide microporous membrane before lamination, and the measurements exhibited a minimal variation. The laminated membrane was found to undergo no lamination-induced deterioration in gas permeability.

The laminated membrane had rates of dimensional change in the sides “a” and “b” respectively of 0.2% and 0.6% after the high-temperature exposure. The laminated membrane underwent shape change of curling alone by the high-temperature exposure. The results demonstrate that the laminated membrane had excellent dimensional stability (shape stability) at high temperatures.

### Comparative Example 1

To 100 parts by weight of a polyamide-imide resin solution, were added 40 parts by weight of a polyvinylpyrrolidone (having a molecular weight of 55000) as a water-soluble polymer and yielded a membrane-forming solution. The polyamide-imide resin solution was a product under the trade name of VYLOMAX HR11NN (Toyobo Co. Ltd.) having a solids concentration of 15 percent by weight and a solution viscosity of 20 dPa·s at 25° C. and using NMP as a solvent. Separately, a PET nonwoven fabric was prepared as a product under the trade name of MF-90 (Japan Vilene Co., Ltd.). This had a thickness of 130 μm, a mass per unit area of about 90 g/m², a density of about 0.69 g/cm³, and an air permeability of 0.1 second. The PET nonwoven fabric was placed on a glass plate; and the membrane-forming solution held at 25° C. was cast onto the nonwoven fabric using a film applicator. The casting was performed with a 51-μm gap between the film applicator and the nonwoven fabric. Immediately after casting, the resulting article was placed and held in a container at a temperature of 50° C. and humidity of about 100% for 4 minutes. The article was then immersed in water for coagulation and cleaning, retrieved from the water without separating a formed membrane from the nonwoven fabric, placed on a wiping paper, air-dried at room temperature, and yielded a laminated membrane integrally including the nonwoven fabric and the microporous membrane. The laminated membrane had a total thickness of about 147 μm.

The prepared laminated membrane was subjected to the tape peel test and found to undergo no interfacial peeling between the nonwoven fabric and the microporous membrane. The laminated membrane was observed with an electron microscope and found as follows. The microporous membrane was in intimate contact with the nonwoven fabric. The microporous membrane had, in its surface, micropores having an average pore diameter of about 0.2 μm. The microporous membrane included, in all over the inside thereof, approximately uniform interconnecting micropores having an average pore diameter of about 0.2 μm. The microporous membrane had an internal porosity of 70%. The laminated membrane was subjected to the air permeability measurement and found to have an average air permeability of 136 seconds, where three measurements were 142, 170, and 96 seconds. This laminated membrane was found to have very inferior gas permeability and to suffer from very large variation as compared with the laminated membrane samples prepared according to Examples 1 to 6.

The values of the surface roughness Sa of the laminated membranes prepared according to Examples 1 to 6 and Comparative Example 1 are indicated in Table 1. The results demonstrate that the laminated membranes according to the embodiment of the present invention obtained by thermal fusion bonding (heat sealing) each had a very low surface roughness; but the laminated membrane according to the comparative example had a relatively high surface roughness. In addition, the results demonstrate that the laminated membranes according to the embodiment of the present invention each had a smooth surface and exhibited high gas permeability; but the laminated membrane according to the comparative example had inferior gas permeability because the microporous membrane made its way deep into the nonwoven fabric.

TABLE 1

| Sample (microporous | Arithmetic mean surface | Air permeability |
|---|---|---|
| laminated membrane) | roughness Sa [μm] | [second] |
| Example 1 | 0.15 | 4 |
| Example 2 | 0.24 | 5 |
| Example 3 | 0.17 | 4 |
| Example 4 | 0.12 | 4 |
| Example 5 | 0.12 | 5 |
| Example 6 | 0.11 | 4 |
| Comparative Example 1 | 0.52 | 136 |

The results of the high-temperature exposure test are collectively indicated in Table 2. For comparison, a commercially available polyolefin separator was subjected to the high-temperature exposure test and found to remarkably shrink in one-side direction and to undergo curling after the test. The commercially available polyolefin separator was a separator available under the trade name of Celgard 2500 (Celgard, LLC. (POLYPORE International Inc.)) having a thickness of about 25 μm. The results demonstrate that this polyolefin separator had very inferior dimensional stability at high temperatures; and that the laminated membranes according to the embodiments of the present invention had good dimensional stability at high temperatures.

TABLE 2

| | Rate of dimensional change | Rate of dimensional change |
|---|---|---|
| Sample | in side “a” [%] | in side “b” [%] |
| Example 1 | 1 | 1 |
| Example 2 | 1.4 | 1.5 |
| Example 3 | 0 | 0.5 |
| Example 4 | 0.4 | 0.5 |
| Example 5 | 1.6 | 0.7 |
| Example 6 | 0.2 | 0.6 |
| Celgard 2500 | 1.2 | 22.1 |

Table 3 gives the measured tensile strengths of the laminated membranes according to Examples 1 to 6 and the microporous membranes according to Production Examples 1 and 2. The results demonstrate that the laminated membranes according to Examples 1 to 6 had higher tensile strengths and offered better handleability as compared with the microporous membranes according to Production Examples 1 and

TABLE 3

| | Tensile strength |
|---|---|
| Sample | [N/15 mm] |
| Example 1 | 48.5 |
| Example 2 | 49.2 |
| Example 3 | 44.5 |
| Example 4 | 46.7 |
| Example 5 | 4.0 |
| Example 6 | 5.2 |
| Production Example 1 | 2.3 |
| (microporous membrane) | |
| Production Example 2 | 3.8 |
| (microporous membrane) | |

### INDUSTRIAL APPLICABILITY

The microporous laminated membrane according to the embodiment of the present invention has excellent pore properties, has a highly smooth surface, is resistant to heat, is flexible, and still can be handled and processed satisfactorily. The microporous laminated membrane is therefore useful as at least part of filters, separation membranes, and separators to be used at high temperatures.

1. A microporous laminated membrane comprising:
a nonwoven-fabric substrate; and
a microporous membrane on at least one side of the nonwoven-fabric substrate,
the microporous membrane comprising a multiplicity of interconnecting micropores, the micropores having an average pore diameter of from 0.01 to 10 μm,
the microporous membrane having an arithmetic mean surface roughness Sa of 0.5 μm or less,
the microporous laminated membrane having an air permeability of from 0.5 to 30 seconds,
the microporous laminated membrane having a tensile strength of 4.0 N/15 mm or more,
the microporous laminated membrane not undergoing interfacial peeling between the substrate and the microporous membrane as a result of a tape peel test,
wherein the tape peel test is performed in a manner as follows:
a masking tape [trade name Film Masking Tape No. 603 (#25) supplied by Teraoka Seisakusho Co., Ltd., having a width of 24 mm] is applied onto a microporous membrane surface of the microporous laminated membrane, compression-bonded to the microporous membrane using a roller having a diameter of 30 mm under a load of 200 gf to give a bonded assembly, and the bonded assembly is subjected to T-peel using a tensile tester at a peel rate of 50 mm/min; and
wherein the arithmetic mean surface roughness Sa is measured by a method as follows:
a surface profile of the microporous membrane is measured by optical interferometry using Non-contact Surface Measurement System VertScan 2.0 (Ryoka Systems Inc.) to calculate the surface roughness, where the measurement is performed in an area of 250 μm by 188 μm, at an objective lens magnification of 50-fold, at a lens barrel size of 0.5 time the body length, using a no-relay zoom lens and a 530 White wavelength filter in a wave measurement mode in a field of view with a size of 640 μm by 480 μm.

2. The microporous laminated membrane according to claim 1,
wherein the microporous membrane is prepared by a method comprising the steps of:
casting a polymer solution onto a backing to form a membrane on the backing;
bringing the membrane on the backing into a coagulation liquid;
separating the membrane alone from the backing; and
drying the separated membrane.

3. The microporous laminated membrane according to claim 1,
wherein the microporous laminated membrane has an arithmetic mean surface roughness Sa of 0.4 μm or less.

4. The microporous laminated membrane according to claim 1,
wherein the microporous laminated membrane has an arithmetic mean surface roughness Sa of 0.3 μm or less.

5. The microporous laminated membrane according to claim 1,
wherein the microporous laminated membrane has an arithmetic mean surface roughness Sa of 0.2 μm or less.

6. The microporous laminated membrane according to claim 1,
wherein the microporous laminated membrane has an air permeability of from 0.5 to 20 seconds.

7. The microporous laminated membrane according to claim 1,
wherein the microporous laminated membrane has an air permeability of from 0.5 to 10 seconds.

8. The microporous laminated membrane according to claim 1,
wherein the microporous laminated membrane has an air permeability of from 0.5 to 5 seconds.

9. The microporous laminated membrane according to claim 2,
wherein the polymer solution is a solution mixture comprising:
8 to 25 percent by weight of a polymer component;
5 to 50 percent by weight of a water-soluble polymer;
0 to 10 percent by weight of water; and
30 to 82 percent by weight of a water-miscible polar solvent.

10. The microporous laminated membrane according to claim 1,
wherein the microporous membrane comprises at least one resin selected from the group consisting of:
polyimide resins;
polyamide-imide resins;
polyetherimide resins; and
polyethersulfone resins.

11. The microporous laminated membrane according to claim 1,
wherein the nonwoven-fabric substrate comprises at least one nonwoven fabric selected from the group consisting of:
polyolefin nonwoven fabrics;
polyamide nonwoven fabrics; and
multilayer nonwoven fabrics comprising at least one nonwoven fabric selected from the group consisting of:
polyolefin nonwoven fabrics; and
polyamide nonwoven fabrics.

12. The microporous laminated membrane according to claim 1,
wherein the microporous membrane has an average internal porosity (pore content) of from 30% to 80%.

13. The microporous laminated membrane according to claim 1,
wherein the substrate has a thickness of from 10 to 500 μm.

14. The microporous laminated membrane according to claim 1,
wherein the microporous laminated membrane has a rate of dimensional change of 5% or less as a result of a high-temperature exposure test,
where the high-temperature exposure test is performed in a manner as follows:
the laminated membrane integrally comprising the substrate and the microporous membrane is trimmed to give an approximately rectangular specimen having a width of about 5 cm and a length of about 10 cm; lengths a1 and b1 of two perpendicular sides of the approximately rectangular specimen are measured, the specimen is placed and left stand in a thermostat controlled at 140° C. for 30 minutes, retrieved from the thermostat, left stand to cool down to room temperature, thereafter lengths a2 and b2 of the two perpendicular sides of the approximately rectangular specimen are measured, rates of dimensional change between a1 and a2 and between b1 and b2 are determined according to formulae below, the rates of dimensional change are averaged, and the average is defined as the rate of dimensional change in the high-temperature exposure test, where the formulae are expressed as follows:
Rate(%) of dimensional change between a1 and a2={|a2−a1|/a1}×100; and
Rate(%) of dimensional change between b1 and b2={|b2−b1|/b1}×100.

15. The microporous laminated membrane according to claim 1,
wherein the microporous laminated membrane is used as at least part of one selected from the group consisting of:
filters for gas, liquid, or solid;
separation membranes for gas, liquid, or solid; and
separators for cell or capacitor use.

16. A method for producing a microporous laminated membrane, the method comprising the steps of:
a) preparing a microporous membrane comprising a first resin;
b) preparing a nonwoven-fabric substrate comprising a second resin; and
c) thermally fusing the nonwoven-fabric substrate with the microporous membrane to thereby give the microporous laminated membrane according to claim 1,
wherein the first resin has a glass transition temperature higher than a melting point of the second resin.

17. The method according to claim 16,
wherein the step a) comprises the substeps of:
a-1) casting a polymer solution onto a backing to form a membrane on the backing;
a-2) bringing the membrane on the backing into a coagulation liquid;
a-3) separating the membrane alone from the backing; and
a-4) drying the separated membrane to give the microporous membrane.

18. The microporous laminated membrane according to claim 2,
wherein the microporous membrane comprises at least one resin selected from the group consisting of:
polyimide resins;
polyamide-imide resins;
polyetherimide resins; and
polyethersulfone resins.

19. The microporous laminated membrane according to claim 3,
wherein the microporous membrane comprises at least one resin selected from the group consisting of:
polyimide resins;
polyamide-imide resins;
polyetherimide resins; and
polyethersulfone resins.

20. The microporous laminated membrane according to claim 4,
wherein the microporous membrane comprises at least one resin selected from the group consisting of:
polyimide resins;
polyamide-imide resins;
polyetherimide resins; and
polyethersulfone resins.
